(19) United States
(12) Patent Application Publication
(10) Pub. No.: US 2008/0166617 A1
(43) Pub. Date: Jul. 10, 2008

(54) Fuel cell and cell assembly for fuel cell

(75) Inventors: Fumishige Shizuku, Komaki-shi (JP); Sogo Goto, Suntou-gun (JP); Hiroo Yoshikawa, Susono-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Toyota Jidosha Kabushiki Kaisha

(21) Appl. No.: 12/007,353

(22) Filed: Jan. 9, 2008

(30) Foreign Application Priority Data
Jan. 10, 2007 (JP) 2007-002120

(51) Int. Cl. H01M 8/10; H01M 2/14

(52) U.S. Cl. 429/30; 429/35

(57) ABSTRACT

A fuel cell includes a membrane-electrode assembly that has an electrolyte membrane and electrodes, a seal portion formed integrally with an outer peripheral portion of the membrane-electrode assembly, gas separators sandwiching the seal portion from both sides, and gas channel-forming portions each made of a porous body which are disposed between the membrane-electrode assembly and the gas separators. The seal portion includes, as projections that are provided on at least one of the two sides thereof and that contact an adjacent gas separator, a first linear projection surrounding the gas channel-forming portions, and a gas stopper projection which is provided at such a position between the first linear projection and the outer periphery of the gas channel-forming portions as to inhibit the gas flow that passes around the gas channel-forming portions, and which is lower in height than the first linear projection.

### INCORPORATION BY REFERENCE

The disclosure of Japanese Patent Application No. 2007-002120 filed on 2007 Jan. 10 including the specification, drawings and abstract is incorporated herein by reference in its entirety.

### BACKGROUND OF THE INVENTION

1. Field of the Invention

The invention relates to a fuel cell and a cell assembly for a fuel cell.

2. Description of the Related Art

A fuel cell is generally formed by sequentially stacking platy members that include electrolyte layers, electrodes or gas separators, in a predetermined order. As an example of this construction, a construction in which an electrolyte membrane is provided integrally with a seal member that is provided on an outer periphery of the electrolyte membrane (see, e.g., Japanese Patent Application Publication No. 2002-42836 (JP-A-2002-42836)). As the seal member is provided on the outer periphery of the electrolyte membrane and the seal member is put in contact with members adjacent to the electrolyte membrane, a gas seal property of gas channels formed on the electrolyte membrane can be secured.

However, in the construction in which the electrolyte membrane and the seal member are integrally formed, and particularly in which gas channels for supplying gases to electrodes formed on the electrolyte membrane are each formed of a porous body, it sometimes happens that a gap is formed between the porous body that forms a gas channel and a site of the seal accomplished by a seal member. If a gap is formed between the porous body and the seal sites, a so-called secondary flow of a gas occurs. Concretely, if there is a gap between the outer periphery of the porous body that is disposed on the electrolyte membrane and forms a gas channel and the seal site of the seal member, the gas preferentially flows through the gap that is less in gas flow resistance than the voids in the porous body. The surrounding of the porous body is not a region where flow of gas is essentially not desired and that does not contribute to the power generation. Therefore, if there occurs gas flowing through the gap (secondary flow of gas), the utilization efficiency of the gas in the fuel cell declines, and the cell performance declines.

### SUMMARY OF THE INVENTION

It is an object of the invention to restrain the decline in the gas utilization rate caused by the voids between the porous body and the seal site in a fuel cell in which the gas channels on the electrodes are formed by a porous body.

A fuel cell in accordance with a first aspect of the invention includes: a membrane-electrode assembly that includes an electrolyte membrane, and electrodes formed on two sides of the electrolyte membrane; a seal portion that is made of an elastic body and that is formed integrally with the membrane-electrode assembly at an outer peripheral portion of the membrane-electrode assembly; gas separators that are each disposed at a predetermined distance from the membrane-electrode assembly so as to sandwich the seal portion from two sides; and gas channel-forming portions that are each made of a porous body and that are disposed between the membrane-electrode assembly and the gas separators, wherein the seal portion includes, as projections that are provided on at least one of two sides of the seal portion and that contact an adjacent one of the gas separators, a first linear projection that surrounds the gas channel-forming portions, and a gas stopper projection which is provided at such a position between the first linear projection and an outer periphery of the gas channel-forming portions as to inhibit a gas flow that does not pass in the gas channel-forming portions, and which is lower in height than the first linear projection.

According to the fuel cell in accordance with the first embodiment of the invention constructed as described above, the seal portion formed integrally with the membrane-electrode assembly includes the gas stopper projection that contacts a gas separator and is provided at such a position as to inhibit the gas flow that does not pass in the gas channel-forming portions, between the gas channel-forming portions and the first linear projection that surrounds the gas channel-forming portions. Therefore, the gas flow around the gas channel-forming portions (the secondary flow of the gas) can be restrained, and the gas utilization efficiency can be improved. In this construction, the gas stopper projection is formed so as to be lower than the first linear projection. Specifically, it suffices that the gas stopper projection be formed so as to be lower than a height that is required of the first linear projection that surrounds the gas channel-forming portion. Therefore, the surface pressure acting in the vicinity of the outer peripheral portion of the gas channel-forming portions does not excessively decline, so that the increase in the contact resistance attributable to the gas stopper projection can be restrained.

The gas stopper projection may have such a height as to restrain leakage of a gas that flows in the gas channel-forming portion. With this construction, the gas stopper projection formed between the first linear projection and the gas channel-forming portions can sufficiently inhibit the flow of the gas that does not pass in the gas channel-forming portions.

The gas stopper projection may be in contact with the outer periphery of the gas channel-forming portions and may surround the gas channel-forming portions. With this construction, no gap is formed between the gas channel-forming portions and the gas stopper projection, so that the gas utilization efficiency can be enhanced.

The fuel cell may further include gas diffusion layers that sandwich the membrane-electrode assembly and are disposed on the electrodes, and that are each made of a porous body whose average pore diameter is smaller than the average pore diameter of the gas channel-forming portions, wherein: the seal portion is formed integrally with the membrane-electrode assembly and with the gas diffusion layer; and the gas channel-forming portions are disposed between the gas diffusion layer and the gas separators. This construction will improve the efficiency in supplying the gases to the electrodes, and will enhance the characteristic of the current collection between the gas channel-forming portions and the electrodes, and will enhance the effect of protecting the electrolyte membranes.

Furthermore, the seal portion may be formed integrally with the membrane-electrode assembly and with the gas channel-forming portion. This construction will further enhance the effect of restraining the secondary flow of the gas acting in the vicinity of the outer peripheral portion of the gas channel-forming portion.

Furthermore, each gas separator may have: a gas supply passage that is formed within the gas separator as a channel of a gas supplied to the gas channel-forming portion; and an opening portion of the gas supply passage that is formed in a contact surface between the gas separator and the gas channel-forming portion. This construction will allow the first linear projection to be formed in such a linear shape as to surround the outer periphery of the gas channel-forming portions without a break, and will allow simplification of the shape of the first linear projection.

Furthermore, the seal portion may be formed integrally with the membrane-electrode assembly and with one of the gas separators adjacent to the membrane-electrode assembly, and a side of the seal portion that contacts the one of the adjacent gas separators may be formed as a flat surface, and may have a surface contact with the one of the adjacent gas separators, and the seal portion may have the first linear projection and the gas stopper projection on a side that contacts another one of the adjacent gas separators. With this construction, the seal portion is formed integrally with the gas separators as well as with the membrane-electrode assembly, so that a fuel cell can be assembled merely by sequentially stacking thus-integrally formed members. Therefore, the operation of assembling a fuel cell can be simplified. Besides, since the first linear projection and the gas stopper projection are formed only on one side of the seal portion, the aforementioned projections become stable and less likely to fall or bend, and therefore the securement of a seal property can be facilitated.

Or, the seal portion may be adhered or closely attached to one of the gas separators adjacent to the seal portion, and the seal portion may have the first linear projection and the gas stopper projection on a side that contacts another one of the adjacent gas separators. With this construction, since the seal portion and the gas separator are adhered or closely attached to each other, the movement of the projections attributable to the gas pressure of the gas that flows in the gas channel-forming portion can be restrained. Besides, since the first linear projection and the gas stopper projection are formed only on one side of the seal portion, the aforementioned projections become stable and less likely to fall or bend, and therefore the securement of a seal property is facilitated.

The fuel cell in accordance with the first aspect of the invention may further have a construction in which the fuel cell is formed by stacking a plurality of membrane-electrode assemblies with the gas separators disposed between the membrane-electrode assemblies, and in which: the gas separators and the seal portion each have, at positions that correspond to each other, a hole portion that forms a gas manifold which penetrates through the fuel cell in a stacking direction and through which a gas to be supplied to each of the membrane-electrode assemblies flows; the first linear projection surrounds the gas channel-forming portion, and is disposed along a portion of an outer periphery of the hole portion; the seal portion further has, as a projection that is provided on at least one of two sides of the seal portion so as to contact an adjacent one of the gas separators, a second linear projection that is continuously provided with a height substantially the same as the height of the first linear projection, and that surrounds the hole portion together with the portion of the first linear projection; and the first linear projection and the second linear projection have such a height as to restrain leakage of the gas that flows in the gas manifold.

With this construction, although the first and second linear projections have such a height as to restrain the leakage of the gas that flows in the gas manifold, the surface pressure acting in the vicinity of the outer peripheral portion of the gas channel-forming portions does not excessively decline, since the gas stopper projection is lower than the first and second linear projections.

A fuel cell in accordance with a second aspect of the invention includes: a membrane-electrode assembly that includes an electrolyte membrane, and electrodes formed on two sides of the electrolyte membrane; a seal portion that is made of an elastic body and that is formed integrally with the membrane-electrode assembly at an outer peripheral portion of the membrane-electrode assembly so as to embrace the outer peripheral portion of the membrane-electrode assembly; gas separators that are each disposed at a predetermined distance from the membrane-electrode assembly so as to sandwich the seal portion from two sides; and gas channel-forming portions that are each made of a porous body and that are disposed between the membrane-electrode assembly and the gas separators. The fuel cell is formed by stacking a plurality of membrane-electrode assemblies with the gas separators disposed between the membrane-electrode assemblies. The gas separators and the seal portion each have, at positions that correspond to each other, a hole portion that forms a gas manifold which penetrates through the fuel cell in a stacking direction and through which a gas to be supplied to each of the membrane-electrode assemblies flows. The seal portion includes, as projections that are provided on at least one of two sides of the seal portion so as to contact an adjacent one of the gas separators, a gas stopper projection that is in contact with an outer periphery of the gas channel-forming portions and that surrounds the gas channel-forming portions, and a linear projection that surrounds an outer periphery of the hole portion and that is higher than the gas stopper projection.

According to the fuel cell in accordance with the second aspect of the invention constructed as described above, the seal portion formed integrally with the membrane-electrode assembly includes the gas stopper projection that is in contact with the outer periphery of the gas channel-forming portions and that surrounds the gas channel-forming portions, the seal portion can restrain the gas flow around the gas channel-forming portions (the secondary flow of the gas), and therefore can improve the gas utilization efficiency. Since the gas stopper projection is formed to be lower than the linear projection that surrounds the hole portion that forms a gas manifold, the surface pressure acting in the vicinity of the outer peripheral portion of the gas channel-forming portions does not excessively decline, so that the increase in the contact resistance attributable to the gas stopper projection can be restrained.

In the fuel cell in accordance with the second aspect of the invention, the gas stopper projection may have such a height as to restrain leakage of the gas that flows in the gas channel-forming portion, and the linear projection may have such a height as to restrain leakage of the gas that flows in the gas manifold. With this construction, the gas stopper projection can sufficiently inhibit the flow of the gas that does not pass in the gas channel-forming portions while achieving the aforementioned effects.

A cell assembly for a fuel cell in accordance with a third embodiment of the invention includes:

a membrane-electrode assembly that includes an electrolyte membrane, and electrodes formed on two sides of the electrolyte membrane; and

a seal portion that is made of an elastic body and that is formed integrally with the membrane-electrode assembly at an outer peripheral portion of the membrane-electrode assembly,

wherein the seal portion includes, as projections that are provided on at least one of two sides of the seal portion and that contacts adjacent gas separators that are each disposed at a predetermined distance from the membrane-electrode assembly so as to sandwich the seal portion from the two sides, a first linear projection that is made of a porous body and that is provided so as to surround gas channel-forming portions disposed between the membrane-electrode assembly and the gas separators, and a gas stopper projection which is provided at such a position between the first linear projection and an outer periphery of the gas channel-forming portions as to inhibit a gas flow that passes around the gas channel-forming portions, and which is lower in height than the first linear projection.

In a fuel cell employing the cell assembly in accordance with the third embodiment of the invention, the gas stopper projection can sufficiently inhibit the flow of the gas that does not pass in the gas channel-forming portions while achieving the foregoing effects.

In the fuel cell, the gas stopper projection may have such a height as to restrain leakage of the gas that flows in the gas channel-forming portion, and the linear projection may have such a height as to restrain leakage of the gas that flows in the gas manifold. With this construction, the gas stopper projection can sufficiently inhibit the flow of the gas that does not pass in the gas channel-forming portions while achieving the aforementioned effects.

A fuel cell in accordance with a fourth embodiment of the invention includes:

a membrane-electrode assembly that includes an electrolyte membrane, and electrodes formed on two sides of the electrolyte membrane;

a seal portion that is made of an elastic body and that is formed integrally with the membrane-electrode assembly at an outer peripheral portion of the membrane-electrode assembly;

gas separators that are each disposed at a predetermined distance from the membrane-electrode assembly so as to sandwich the seal portion from two sides; and

gas channel-forming portions that are each made of a porous body and that are disposed between the membrane-electrode assembly and the gas separators,

wherein the seal portion includes, as projections that are provided on at least one of two sides of the seal portion and that contact an adjacent one of the gas separators, a first linear projection that surrounds the gas channel-forming portions, and a gas stopper projection which is provided at such a position between the first linear projection and an outer periphery of the gas channel-forming portions as to inhibit a gas flow that passes around the gas channel-forming portions, and which is lower in a pressing pressure on the gas separator after assembly of the fuel cell than the first linear projection.

In the fuel cell in accordance with the fourth embodiment of the invention, the gas stopper projection can sufficiently inhibit the flow of the gas that does not pass in the gas channel-forming portions while achieving the aforementioned effects.

The invention can be realized in various forms other than the above-described constructions. For example, the invention can also be realized in the form of a manufacture method for a fuel cell, or the like.

### BRIEF DESCRIPTION OF THE DRAWINGS

The foregoing and further features and advantages of the invention will become apparent from the following description of example embodiments with reference to the accompanying drawings, wherein like numerals are used to represent like elements, and wherein:

FIG. 1 is a schematic sectional view depicting an overall construction of a fuel cell of an embodiment of the invention;

FIG. 2 is an illustrative diagram showing an enlarged view of an X region surrounded by a dashed line in FIG. 1;

FIG. 3 is a plan view depicting an overall construction of a cell assembly 10;

FIG. 4 is a plan view showing the shape of a cathode-side plate 31;

FIG. 5 is an illustrative diagram showing the shape of an anode-side plate 32;

FIG. 6 is an illustrative diagram showing the shape of an intermediate plate 33;

FIG. 7 is a schematic sectional view of a seal portion 16 formed integrally with a power generation laminate portion 11 and with a gas separator 30;

FIG. 8 is an illustrative diagram depicting a manufacture process of a fuel cell in accordance with the embodiment;

FIG. 9 is an illustrative diagram depicting a state in which, through injection molding, the seal portion 16 is formed integrally;

FIGS. 10A and 10B are plan views depicting modifications of the cell assembly; and

FIG. 11 is a plan view depicting a cell assembly in accordance with still another modification.

### DETAILED DESCRIPTION OF EMBODIMENTS

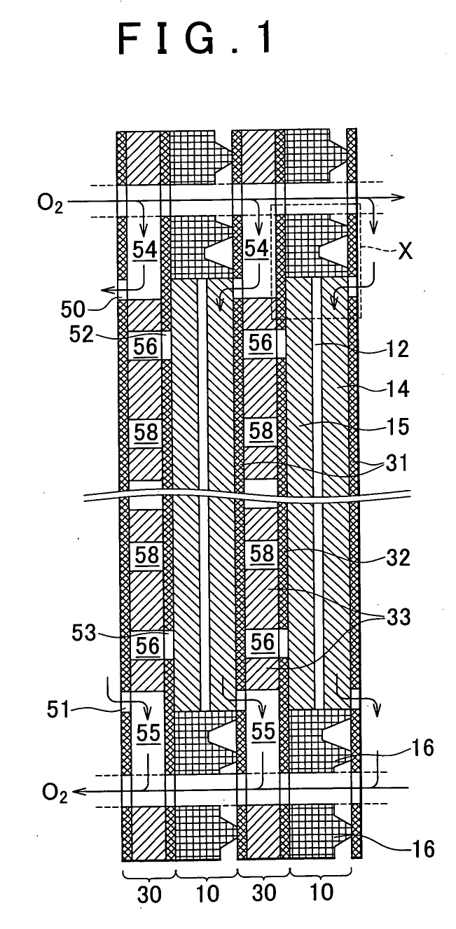

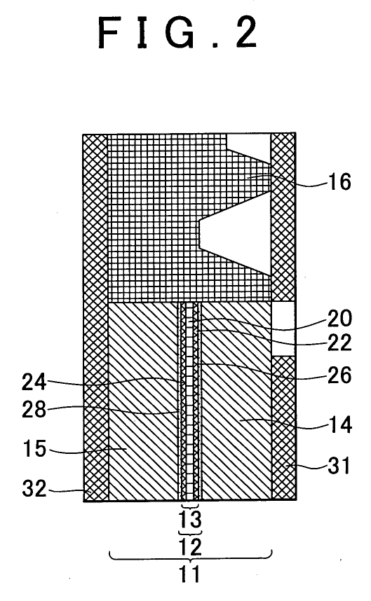

FIG. 1 is a schematic sectional view depicting an overall construction of a fuel cell of an embodiment, and FIG. 2 is an illustrative diagram showing an enlarged view of an X region surrounded by a dashed line in FIG. 1. The fuel cell of the embodiment is a solid polymer fuel cell. Besides, the fuel cell of this embodiment includes a plurality of cell assemblies 10 each of which is a unit where the electrochemical reactions progress, and has a stack structure in which the cell assemblies are stacked with gas separators 30 interposed between the individual cell assemblies 10.

Each cell assembly 10 is constructed of a power generation laminate portion 11 and seal portions 16 as shown in FIG. 2. The power generation laminate portion 11 is constructed of a power generation body 12, and a pair of gas channel-forming portions 14, sandwiching the power generation body 12. The power generation body 12 is formed by an MEA (Membrane Electrode Assembly) 13 that is made up of an electrolyte membrane 20 and electrodes (a cathode 22 and an anode 24) formed on surfaces of the electrolyte membrane 20, and a pair of gas diffusion layers 26, 28 sandwiching the MEA 13.

The electrolyte membrane 20 is a proton-conducting ion exchange membrane formed from a solid polymer material, for example, a fluorine-based resin containing perfluorocarbon sulfonic acid. The electrolyte membrane 20 exhibits good electric conductivity in a moist state. The cathode 22 and the anode 24 are each provided with a catalyst that accelerates electrochemical reactions, for example, platinum, or an alloy made of platinum and another metal. The cathode 22 and the anode 24 can each be formed by, for example, preparing a carbon powder loaded with a catalyst metal, such as platinum or the like, and preparing a paste through the use of the catalyst-loaded carbon and an electrolyte substantially the same as the electrolyte that constitutes the electrolyte membrane 20, and then applying the prepared paste to the electrolyte membrane 20. The gas diffusion layers 26, 28 are carbon-made porous members that are formed by, for example, a carbon cloth or a carbon paper. The MEA 13 in which the catalyst electrodes are formed on the electrolyte membrane 20 is integrated with the gas diffusion layers 26, 28 by press joining, thus making a power generation body 12. The gas diffusion layers 26, 28 are each constructed of a porous body whose average, pore diameter is smaller than that of the gas channel-forming portions 14, 15 described below. Therefore, the provision of the gas diffusion layers 26, 28 improves the efficiency in supplying gases to the catalyst electrodes, and enhances the current collection between the gas channel-forming portions 14, 15 and the catalyst electrodes, and also protects the electrolyte membrane 20. However, the provision of the gas diffusion layers 26, 28 may also be omitted, depending on the component materials and the porosity of the gas channel-forming portions 14, 15.

The gas channel-forming portions 14, 15 are each an electroconductive thin platy member formed by a metal-made porous body, such as a foamed metal, a metal mesh, etc., or a porous body made of carbon. In this embodiment, a porous body made of titanium is used. The gas channel-forming portions 14, 15 are disposed gaplessly between the power generation body 12 and the gas separators 30. The spaces made up of many pores formed in the gas channel-forming portions 14, 15 function as inside-cell gas channels through which a gas to be consumed in the electrochemical reactions pass. Specifically, the spaces formed by the pores of the gas channel-forming portion 14 disposed between the cathode 22 and the gas separator 30 function as inside-cell oxidizing gas channels through which an oxidizing gas containing oxygen passes. The spaces formed by the pores of the gas channel-forming portion 15 disposed between the anode 24 and the gas separator 30 function as inside-cell fuel gas channels through which a fuel gas containing hydrogen passes.

A seal portion 16 is provided at a location that is between adjacent gas separators 30 and that is at an outer peripheral portion of the power generation laminate portion 11. The seal portion 16 is formed by an elastic material, that is, a rubber (e.g., silicon rubber, butyl rubber, fluororubber), or a thermoplastic elastomer. As shown in FIG. 2, one side of the seal portion 16 is formed as a flat surface, and has a surface contact with an adjacent one of the gas separators 30. On this contact surface, the seal portion 16 is adhered and closely attached to the gas separator 30 with a predetermined binding force. The other side of the seal portion 16 has projections, and vertex portions of the projections contact the other one of the gas separators 30. The seal portion 16, together with the power generation laminate portion 11, is formed integrally with one of the adjacent gas separators 30 with which the flat surface of the seal portion 16 has a surface contact. A manufacture process of the seal portion 16 will be later described in detail.

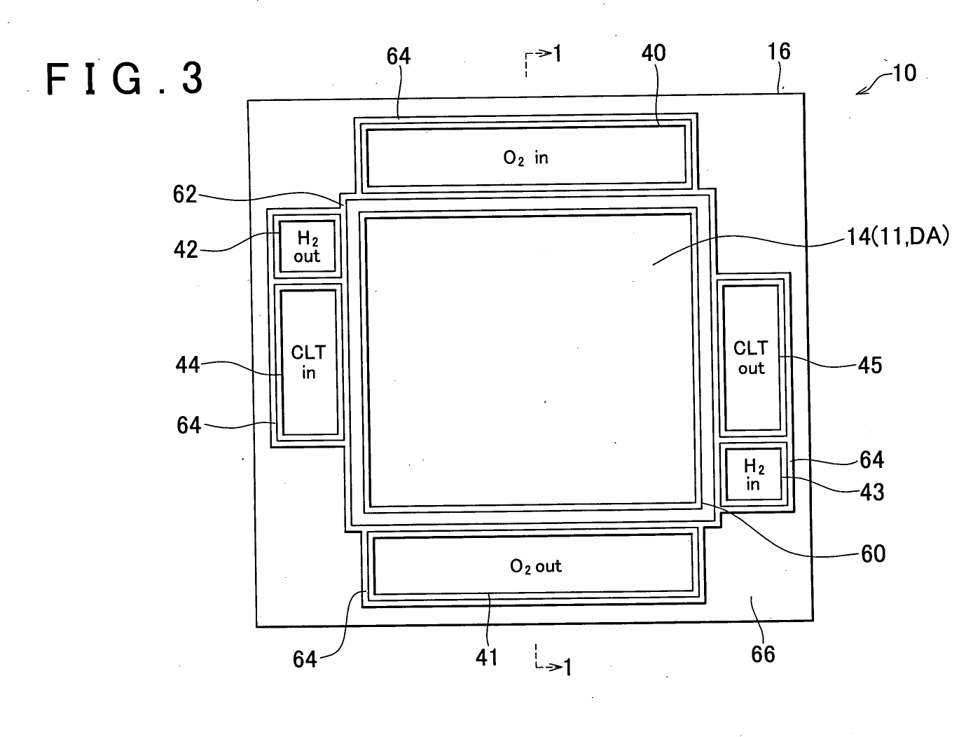

FIG. 3 is a plan view depicting an overall construction of a cell assembly 10 in which the power generation laminate portion 11 and the seal portion 16 are integrally formed. As shown in FIG. 3, the seal portion 16 is a generally quadrangular thin platy member, and has six hole portions (below-described six hole portions 40 to 45) provided in the outer peripheral portion, and a generally quadrangular hole portion provided in a central portion of the seal portion 16 in which the power generation laminate portion 11 is incorporated. FIG. 3 is a view taken from the right side in FIG. 1, and depicts a side of the seal member 16 that has the projections described above. In FIG. 3, the gas channel-forming portion 14 shows on the surface of the power generation laminate portion 11 that is fitted in the hole portion provided in the central portion. The projections formed on the seal portion 16 are constructed of a gas stopper projection 60 and linear projections.

As shown in FIG. 3, the gas stopper projection 60 is a generally quadrangular projection that is in contact with the outer periphery of the gas channel-forming portion 14 incorporated in the hole portion provided in the central portion of the seal portion 16, and that surrounds the gas channel-forming portion 14. Besides, the linear projections are projections formed apart from the gas stopper projection 60, and include a first linear projection 62 and a second linear projection 64. The first linear projection 62 is a generally quadrangular projection provided outside the gas stopper projection 60, and surrounds the gas channel-forming portion 14. The second linear projection 64 is a linear projection that is formed continuously to the first linear projection 62 so as to surrounds each six hole portions provided in the outer peripheral portion of the seal portion 16 together with the first linear projection 62. Since the seal portion 16 is made of a resin material that has elasticity, gas seal property can be secured at sites of contact of the gas stopper projection 60 and the linear projections 62, 64 with the gas separators 30 when the seal portions 16 in a fuel cell receive pressurizing force in a direction parallel to the stacking direction. It is to be noted herein that the gas stopper projection 60 and the linear projections 62, 64 are each formed so as to be substantially consistent in height and also in the width of the vertex portion. Therefore, the gas stopper projection 60 surrounding the gas channel-forming portion 14 or the linear projections surrounding the six hole portions can produce a substantially uniform stress as a whole between adjacent gas separators 30, and therefore can realize good gas seal property. Incidentally, the heights of the gas stopper projection 60 and the linear projections are related to a part of the invention, and will be later described in detail. Besides, in the following description, a region in the power generation laminate portion 11 that corresponds to a portion exposed in the hole portion formed in the central portion of the seal portion 16 will be termed the power generation region DA.

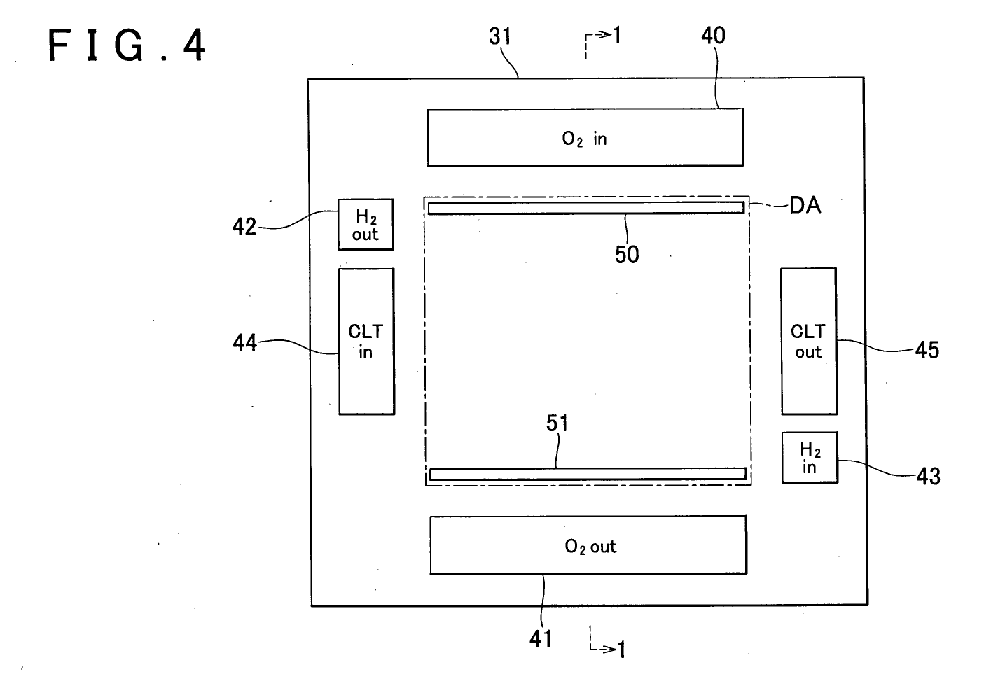

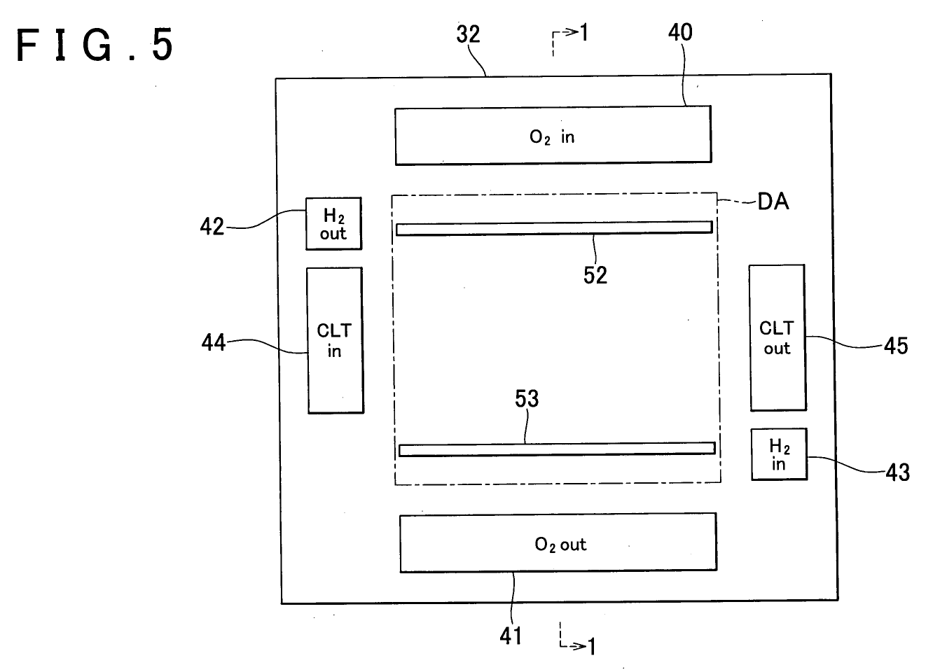

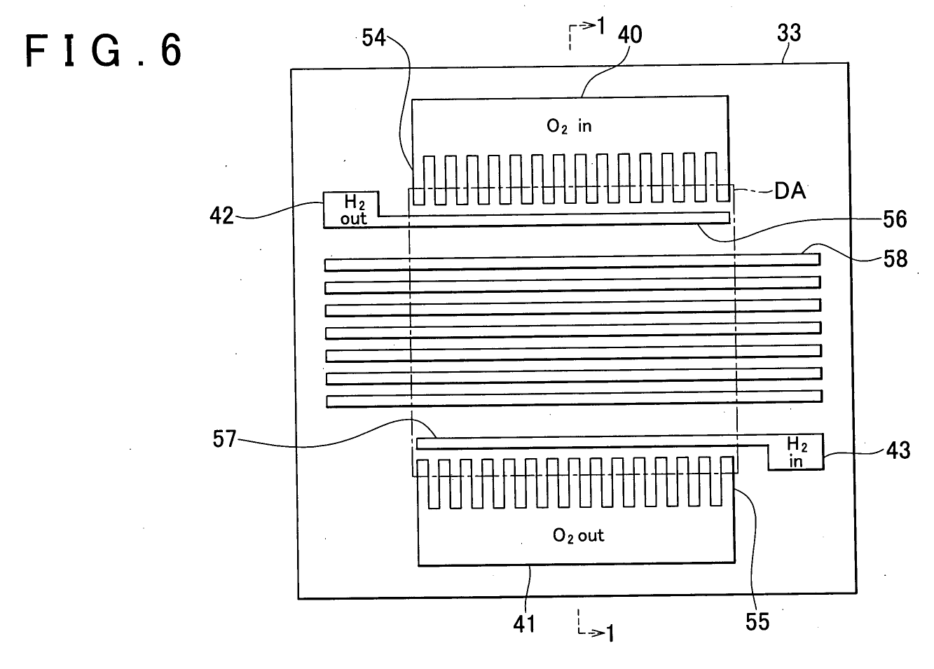

The gas separator 30, as shown in FIG. 1, includes a cathode-side plate 31 that contacts the gas channel-forming portion 14, an anode-side plate 32 that contacts the gas channel-forming portion 15, and an intermediate plate 33 sandwiched by the cathode-side plate 31 and the anode-side plate 32. These three plates are thin platy members formed by an electroconductive material, for example, a metal such as stainless steel, titanium, an titanium alloy, etc. The plates are superimposed on each other in the order of the cathode-side plate 31, the intermediate plate 33 and the anode-side plate 32, and are joined together, for example, by diffusion joining. The three plates each have flat surfaces without asperity, and each have hole portions of predetermined shapes at predetermined positions. FIG. 4 is a plan view showing the shape of the cathode-side plate 31, and FIG. 5 is an illustrative diagram showing the shape of the anode-side plate 32, and FIG. 6 is an illustrative diagram showing the shape of the intermediate plate 33. FIGS. 4 to 6 are diagrams depicting the individual plates viewed from the same side as the side from which the seal portion 16 is viewed in FIG. 3, i.e., from the right side in FIG. 1. In FIGS. 4 to 6, the above-described power generation region DA is shown surrounded by a one-dot dashed line.

Both the cathode-side plate 31 and the anode-side plate 32 have in the outer peripheral portion thereof six hole portions that are provided at the same positions as the six holes in the seal portion 16. When the thin platy members are stacked to form a stack structure, the six holes are superimposed on each other to form manifolds that conduct fluids in the stacking direction within the fuel cell. In each of the aforementioned thin platy members, a hole portion 40 is formed near a side of the generally quadrangular periphery thereof. A hole portion 41 is formed near a side opposite to the side near which the hole portion 40 is formed. Furthermore, hole portions 42, 44 are formed near one of the other two sides, and hole portions 43, 45 are formed near the other one of the two sides. In addition, in the intermediate plate 33, the hole portions 44, 45 of the aforementioned six hole portions are not provided, but a plurality of coolant openings 58 are provided so as to overlap the positions that correspond to the hole portions 44, 45.

The hole portions 40 of the thin platy members form an oxidizing gas-supplying manifold that distributes the oxidizing gas supplied to the fuel cell to the individual inside-cell oxidizing gas channels (indicated as “O₂ IN” in the drawing). The hole portions 41 of the thin platy members form an oxidizing gas-discharging manifold that conducts to the outside of the oxidizing gas that gathers after being discharged from the inside-cell oxidizing gas channel (indicated as “O₂ OUT” in the drawing). Besides, the hole portions 43 of the thin platy members form a fuel gas-supplying manifold that distributes the fuel gas supplied to the fuel cell to the individual inside-cell fuel gas channels (indicated as “H₂ IN” in the drawing). The hole portions 42 of the thin platy members form a fuel gas-discharging manifold that conducts to the outside of the fuel gas gathering after being discharged from the inside-cell fuel gas channels (indicated as “H₂ OUT” in the drawing). Furthermore, the hole portions 44 form a coolant-supplying manifold that distributes the coolant supplied to the fuel cell, such as cooling water or the like, into the individual gas separators 30 (indicated as “CLT IN” in the drawing). The hole portions 45 form a coolant-discharging manifold that conducts to the outside of the coolant gathering after being discharged from the gas separators 30 (indicated as “CLT OUT” in the diagram).

The cathode-side plate 31 has an oxidizing gas-supplying slit 50 that is provided along a side of the power generation region DA (an upper end portion thereof in FIG. 4) near a plate center-side side of the generally quadrangular hole portion 40, and that penetrates through the cathode-side plate 31. Likewise, the cathode-side plate 31 has an oxidizing gas-discharging slit 51 that is provided along another side of the power generation region DA (a lower end portion thereof in FIG. 4) near a plate center-side side of the quadrangular hole portion 41 (see FIG. 4).

The anode-side plate 32, similar to the cathode-side plate 31, has a fuel gas-discharging slit 52 that is provided along a side of the power generation region DA (an upper end portion thereof in FIG. 5) near the plate center-side side of the generally quadrangular hole portion 40, and that penetrates through the anode-side plate 32. Besides, the anode side plate 32 also has a fuel gas-supplying slit 53 that is provided along another side of the power generation region DA (a lower end portion thereof in FIG. 45) near the plate center-side side of the generally quadrangular hole portion 41 (see FIG. 5). The fuel gas-discharging slit 52 and the fuel gas-supplying slit 53 are disposed near to the center of the plate so as not to overlap with the oxidizing gas-supplying slit 50 or the oxidizing gas-discharging slit 51.

In the intermediate plate 33, the shape of the hole portion 40 is different from the shape thereof in the other plates. The plate center-side side of the hole portion 40 of the intermediate plate 33 has a plurality of protruded portions that are protruded in the direction toward the center of the plate. The plurality of protruded portions of the hole portion 40 will be termed communication portions 54. The communication portions 54 are formed so as to lie over the oxidizing gas-supplying slit 50 when the intermediate plate 33 and the cathode-side plate 31 are stacked. Thus, the communication portion 54 links the oxidizing gas-supplying manifold and the oxidizing gas-supplying slit 50 in communication. Likewise, the hole portion 41 is provided with a plurality of communication portions 55 that correspond to the oxidizing gas-discharging slit 51 (see FIG. 6). Furthermore, the intermediate plate 33 is provided with a communication portion 57 and a communication portion 56 that communicate with the hole portion 43 and the hole portion 42, respectively, and that have such a shape as to lie over the fuel gas-discharging slit 52 or the fuel gas-supplying slit 53 of the anode-side plate 32.

Inside the fuel cell, the oxidizing gas flowing in the oxidizing gas-supplying manifold formed by the hole portions 40 flows into the inside-cell oxidizing gas channel formed within the gas channel-forming portion 14, via a space formed by the communication portion 54 of the intermediate plate 33, and the oxidizing gas-supplying slit 50 of the cathode-side plate 31. In the inside-cell oxidizing gas channel, the oxidizing gas flows in directions parallel to the gas channel-forming portion 14 (planar directions), and also diffuses further in a direction perpendicular to the planar directions (in the stacking direction). The oxidizing gas having diffused in the stacking direction reaches the cathode 22, flowing through the gas diffusion layer 26 from the gas channel-forming portion 14, and consumed in the electrochemical reactions. The oxidizing gas having passed through the inside-cell oxidizing gas channel while contributing to the electrochemical reactions is discharged from the gas channel-forming portion 14 into the oxidizing gas-discharging manifold formed by the hole portions 41, via the oxidizing gas-discharging slit 51 of the cathode-side plate 31 and the space formed by the communication portion 55 of the intermediate plate 33. Likewise, inside the fuel cell, the fuel gas flowing in the fuel gas-supplying manifold formed by the hole portions 43 flows into the inside-cell fuel gas channel formed within the gas channel-forming portion 15, via the space formed by the communication portion 57 of the intermediate plate 33 and the fuel gas-supplying slit 53 of the anode-side plate 32. In the inside-cell fuel gas channel, the fuel gas flows in the planar directions, and also diffuses further in the stacking direction. The fuel gas having diffused in the stacking direction flows through the gas diffusion layer 28 from the gas channel-forming portion 15, and reaches the anode 24, where the fuel gas is consumed in the electrochemical reactions. The fuel gas having passed through the inside-cell fuel gas channel while contributing to the electrochemical reaction is discharged from gas channel-forming portion 15 into the fuel gas-discharging manifold formed by the hole portions 42, via the fuel gas-discharging slit 52 of the anode-side plate 32 and the space formed by the communication portion 56 of the intermediate plate 33.

In FIGS. 3 to 6, the position that corresponds to the sectional view shown in FIG. 1 is shown as a 1-1 section. FIG. 1 shows a manner in which the oxidizing gas is supplied, in the 1-1 section, from the oxidizing gas-supplying manifold formed by the hole portions 40 into the gas channel-forming portion 14, via the communication portion 54 of the intermediate plate 33 and the oxidizing gas-supplying slit 50 of the cathode-side plate 31. Furthermore, as shown in FIG. 1, in the 1-1 section, the oxidizing gas is discharged from the gas channel-forming portion 14 into the oxidizing gas-discharging manifold formed by the hole portions 41, via the oxidizing gas-discharging slit 51 of the cathode-side plate 31 and the communication portion 55 of the intermediate plate 33.

The intermediate plate 33 further has a plurality of elongated coolant openings 58 that are formed in parallel with each other in a region that includes the power generation region DA. When the intermediate plate 33 is superimposed on the other thin platy members, end portions of the coolant openings 58 become superimposed on the hole portions 44, 45 to form intercellular coolant channels for the coolant to flow through, within the gas separator 30. Specifically, inside the fuel cell, the coolant flowing in the coolant-supplying manifold formed by the hole portions 44 is distributed into intercellular coolant channels formed by the coolant openings 58, and the coolant discharged from the intercellular coolant channels is discharged into the coolant-discharging manifold that the hole portions 45 form.

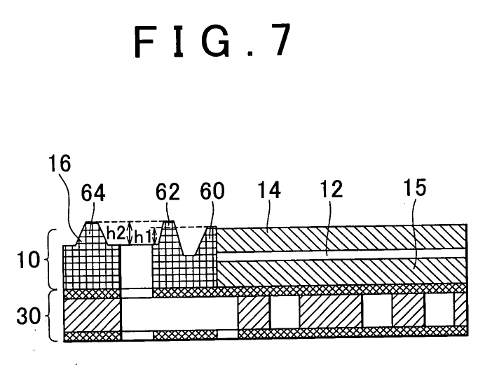

In this embodiment, when a fuel cell is made, the seal portion 16 is formed integrally with one of adjacent gas separators 30, as well as with the power generation laminate portion 11. FIG. 7 is a schematic sectional view of the seal portion 16 formed integrally with the power generation laminate portion 11 and with one of adjacent gas separators 30. As shown in FIG. 7, in the seal portion 16, the first linear projection 62 and the second linear projection 64 are formed so as to have substantially the same height (h2), and the height (h2) is greater than a height (h1) of the gas stopper projection 60. In addition, the heights h1, h2 of the projections shown in FIG. 7 represent heights with respect to a flat portion 66 (see FIG. 3) that is formed to be flat near the outer periphery of the seal portion 16.

The height of the gas stopper projection 60 is greater than or equal to the height of the gas channel-forming portion 14 when the gas channel-forming portion 14 is formed integrally with the seal portion 16. Then, the height of the gas stopper projection 60 is a height that causes, between the gas stopper projection 60 and an adjacent gas separator 30, a stress that can restrain the leakage of the gas flowing in the gas channel-forming portion 14 when a fuel cell is assembled by applying a fastening pressure in a stacking direction to a stack body that is formed by stacking cell assemblies 10 and gas separators 30. This height can be appropriately set in accordance with the pressure of the oxidizing gas flowing in the inside-cell oxidizing gas channel formed in the gas channel-forming portion 14, the fastening pressure applied to the stack body, or the component materials of the seal portion 16, etc. Besides, the height of the first and second linear projections 62, 64 is a height that causes, between the first and second linear projections 62, 64 and an adjacent gas separator 30, a stress that can restrain the leakage of the gas and the coolant flowing in the gas manifold and the coolant manifold, when a fuel cell is assembled as described above. This height can be appropriately set in accordance with the pressure of the fluid that flows in the manifold, the fastening pressure applied to the stack body, the component materials of the seal portion 16, or the like.

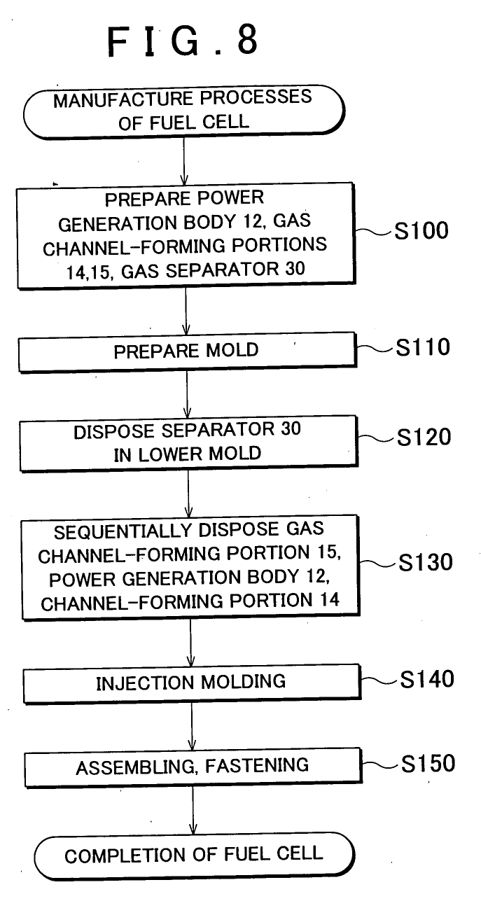

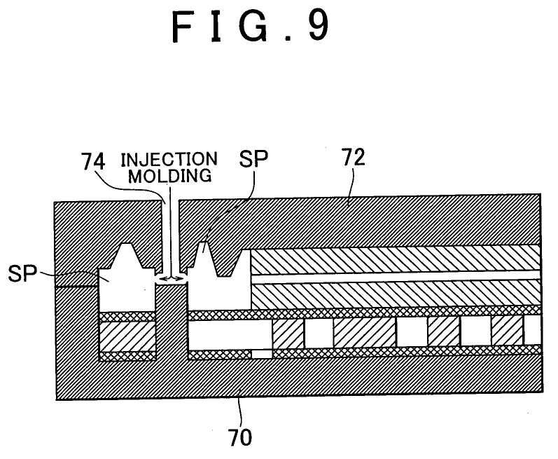

FIG. 8 is an illustrative diagram depicting a manufacture process of a fuel cell in accordance with the embodiment. FIG. 9 is an illustrative diagram depicting a state in which, through injection molding using a mold of a predetermined shape, the seal portion 16 is formed integrally with the power generation laminate portion 11 and the gas separator 30.

When the fuel cell of this embodiment is to be manufactured, the power generation body 12, the gas channel-forming portions 14, 15 and the gas separator 30 are firstly prepared (step S100). Besides, a mold for molding the seal portion 16 integrally with the components is prepared (step S110). The mold includes an upper mold 72 and a lower mold 70 as shown in FIG. 9. The interior of the mold is provided with projected and depressed shapes to which the gas separator 30, the power generation body 12 and the gas channel-forming portions 14, 15 just fit.

Next, a gas separator 30 is disposed in the lower mold 70 (step S120). In this embodiment, the gas separator 30 is disposed with the cathode-side plate 31 facing downward and with the anode-side plate 32 facing upward. Then, the gas channel-forming portion 15, the power generation body 12 and the gas channel-forming portion 14 are sequentially disposed on the gas separator 30 disposed as described above (step S130).

After the members are disposed in the mold, the mold is fastened with a predetermined mold pressure and the injection molding is performed to integrally form the seal portion 16 (step S140). As shown in FIG. 9, in the mold in which the members are disposed, a space SP having a shape of the seal portion 16 is formed near the outer edge of the power generation laminate portion 11. As shown in FIG. 9, the space SP is defined by the anode-side plate 32-side surface of the gas separator 30, inner wall surfaces of the lower mold 70 and the upper mold 72, and the end portions of the power generation laminate portion 11. Besides, in the upper mold 72 of the mold, a penetration hole with an opening 74 that penetrates therethrough in the thickness direction is formed at the position where the manifold hole portions 40 to 45 are formed. At the time of the injection molding, a liquid rubber as a molding material of the seal portion 16 is loaded into the space SP from the openings 74 through the penetration holes. After that, a vulcanization process is performed. In this embodiment, the mold fastening is performed so that the pressure equal to the fastening pressure that will be applied to the fuel cell at the time of the assembly of the fuel cell is applied to the power generation laminate portion 11 and the gas separator 30 at the time of the injection molding. That is, the integral molding of the seal portion 16 is performed while the same state in the fuel cell stacked is assumed.

In this injection molding, the loading pressure of the molding material is controlled so that the molding material fills end portions of the gas diffusion layers 26, 28 and the gas channel-forming portions 14, 15, that is, so that the molding material enters the pores in an outer peripheral portion of the porous body so as to integrate the power generation laminate portion 11 and the seal portion 16. Besides, by adding a silane coupling agent to the molding material, binding force on the contact surface between the seal portion 16 and the gas separator 30 is secured, and the seal portion 16 and the gas separator 30 are adhered and closely attached to each other. After the injection molding, the mold is opened, and a constitution unit in which the cell assembly 10 and the gas separator 30 are integrated is obtained.

After a plurality of constitution units are made in this manner, these constitution units are stacked. Furthermore, a current collection plate provided with an output terminal, an electrically insulating plate formed by an electrically insulating material, and an end plate with high rigidity are further stacked on each of the two opposite sides of the stack body formed by constitution units, thus assembling the stack body. Then, the assembled stack body is fixed while applying a fastening force thereto in the stacking direction (step S150). Thus, a fuel cell is completed.

According to the fuel cell of the embodiment constructed as described above, the seal portion 16 formed integrally with the power generation laminate portion 11 includes a gas stopper projection 60 that contacts the outer periphery of the gas channel-forming portion 14 and surrounds the gas channel-forming portion 14. Therefore, it does not happen that the oxidizing gas flows around the gas channel-forming portion 14 (gas forms a secondary flow) without passing through the interior of the gas channel-forming portion 14, but the supplied oxidizing gas flows in the gas channel-forming portion 14, so that the utilization rate of the oxidizing gas can be improved.

According to the fuel cell of this embodiment, the seal portion 16 includes linear projections 62, 64 that are provided apart from the gas stopper projection 60, in addition to the gas stopper projection 60. The gas stopper projection 60 is formed so as to have a less height in the stacking direction than the linear projections 62, 64. Concretely, the gas stopper projection 60 has such a height as to curb the leakage of the gas flowing in the gas channel-forming portion 14, but is formed so as to be lower than the linear projections 62, 64 that have such a height as to curb the leakage of the gas flowing in the manifold. As described above, since the sites of seal accomplished by the seal portion (the projections provided in seal portion) are provided very close to the outer periphery of the gas channel-forming portion 14, the secondary flow of the gas can be curbed. However, if the gas stopper projection is excessively high, there is a possibility of the surface pressure on the outer periphery-adjacent region of the gas channel-forming portion 14 becoming insufficient. In the region in the gas channel-forming portion 14 in which the surface pressure becomes insufficient, the contact resistance increases, so that a decline in the cell performance is caused. In this embodiment, since the gas stopper projection 60 that contacts the gas channel-forming portion 14 is formed to be relatively low, it does not happen that the surface pressure on the outer periphery-adjacent region of the gas channel-forming portion 14 is made excessively low, and the increase in contact resistance attributable to the gas stopper projection 60 can be curbed.

When the seal portion 16 is integrally formed, the gas channel-forming portion 14 may be prepared as a separate member, unlike the embodiment. In the case where the gas channel-forming portion 14 is prepared as a separate member and is then fitted to the seal portion 16, too, substantially the same effects as described above can be attained, that is, the secondary flow of the gas can be restrained while the surface pressure on the outer periphery-adjacent portion of the channel-forming portion 14 is restrained, if the seal portion 16 is provided with the gas stopper projection 60 that contacts the outer periphery of the gas channel-forming portion 14 and surrounds the gas channel-forming portion 14, and that is relatively low in height. However, in the case where the seal portion 16 is formed integrally with the gas channel-forming portion 14 as well, the molding material of the seal portion 16 enters the pores in the vicinity of the outer periphery of the gas channel-forming portion 14, thus further enhancing the effect of restraining the secondary flow of the gas in the vicinity of the outer peripheral portion of the gas channel-forming portion 14. In addition, as for the gas channel-forming portion 15 provided on the anode side where no projection is formed, the gas channel-forming portion 15 is formed integrally with the seal portion 16 without a gap therebetween, so that the secondary flow of the gas can be sufficiently restrained.

Furthermore, since the seal portion 16 is formed integrally with the gas channel-forming portions 14, 15, there is no requirement for such an accuracy as to make it possible to perform the exact positioning in order to cause the seal portion 16 to contact the outer peripheries of the gas channel-forming portions 14, 15 when the seal portion 16 is formed. Therefore, the gas channel-forming portion 14 and the gas stopper projection 60 can easily be caused to contact each other.

Furthermore, according to this fuel cell, at one side surface of the seal portion 16, the gas stopper projection 60 and the linear projections 62, 64 contact the adjacent gas separator 30, while at the other side surface, the flat surface has a surface contact with another gas separator 30. Thus, since the projections that contact the gas separator 30 to secure a seal property are provided only on one side of the seal portion 16 and the other side has a surface contact, the projections become more stable and less likely to fall or bend and therefore it becomes easier to secure a seal property than in the case where projections are provided on both sides of the seal portion 16. In particular, on the side of the surface contact, the seal portion 16 and the gas separator 30 are adhered and closely attached to each other, so that it is possible to restrain the movement of the projections due to the gas pressure in the manifolds or the inside-cell gas channels.

Furthermore, according to the fuel cell of this embodiment, the seal portion 16 is formed integrally with the power generation laminate portion 11 and the gas separator 30, so as to make a constitution unit in which the cell assembly 10 and the gas separator 30 are integrated. Therefore, a fuel cell can be assembled merely by stacking a plurality of such constitution units. Thus, the assembly operation of the fuel cell can be simplified.

Furthermore, in this embodiment, the gas separator 30 has, in an inner portion thereof, channels for the gases to be supplied to gas channel-forming portions 14, 15, and the opening portions of the channels for the gases are formed in the surfaces of the gas separator 30 that contact the gas channel-forming portions 14, 15. Therefore, the gas stopper projection 60 and the linear projections 62, 64 can be formed in such linear shapes as to surround, without a break, the outer periphery of the gas channel-forming portion 14 and the outer peripheries of the manifold hole portions 40 to 45. Therefore, the shapes of the projections can be simplified. Incidentally, the contact surface between the gas separator 30 and a gas channel-forming portion 14, 15 may not be a flat surface, and it suffices that the gas channel-forming portion 14, 15 be disposed gaplessly between the power generation body 12 and the gas separator 30.

At the time of making the aforementioned constitution unit, the MEA 13 and the gas diffusion layers 26, 28 may also be disposed as separate bodies in a mold so as to be integrally molded with the seal, portion 16, instead of integrating the MEA 13 and the gas diffusion layers 26, 28 beforehand. At the time of integral molding, the mold fastening is performed so that a pressure equal to the fastening pressure applied to a fuel cell is applied. Therefore, the integral molding with the seal portion 16 and the press joining of the MEA 13 and the gas diffusion layers 26, 28 can be simultaneously performed.

Besides, the seal portion 16 integrally molded with the power generation laminate portion 11 may also be formed by a method other than injection molding. For example, the seal portion 16 may also be integrally molded by compression molding. In this case, it suffices to perform a vulcanization compression molding in which molding and vulcanization are simultaneously performed by filling the space SP in the mold with a solid unvulcanized rubber, and fastening and heating the mold.

In this embodiment, as shown in FIG. 9, the members constituting the power generation laminate portion 11 have substantially the same size, and are superimposed on each other, and the end portions of the power generation laminate portion 11 each have a single flat surface. However, a different construction may also be adopted. Specifically, the MEA 13, the gas diffusion layers 26, 28 and the gas channel-forming portions 14, 15 may also be formed so as to have different sizes, or may also be disposed so that the positions of the outer peripheries of the members are deviated from each other.

It is to be noted herein that the invention is not limited to the foregoing embodiment or examples. On the contrary, the invention can be carried out in various manners without departing from the gist of the invention. For example, the following modifications are possible.

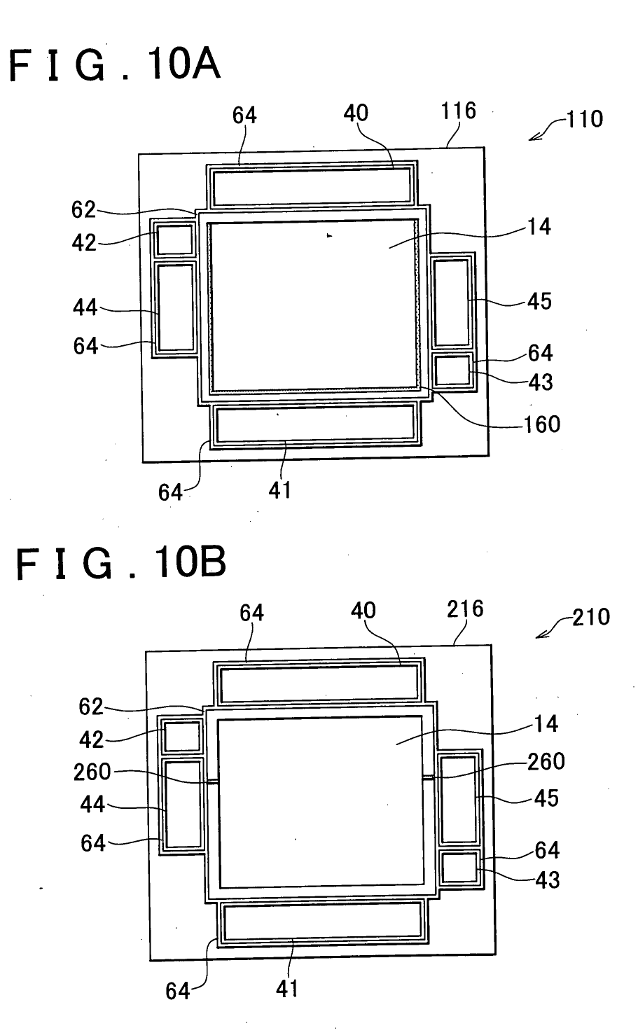

Although in the foregoing embodiment, the gas stopper projection 60 has such a shape as to surround the entire outer periphery of the gas channel-forming portion 14, the gas stopper projection 60 may also have a different shape. For example, instead of surrounding all the four sides of the gas channel-forming portion 14, the gas stopper projection 60 may also have such a shape as to surround three of the four sides. An example of the construction is shown as a cell assembly 110 that includes a seal portion 116 provided with a gas stopper projection 160 in FIG. 10A, in a plan view similar to that shown in FIG. 3. In FIG. 10A, the same portions as those in the foregoing embodiment are assigned with the same reference numerals, and the gas stopper projection 160 is shown by dot shading. In this construction, although a space is formed between the gas stopper projection 160 and the first linear projection 62, no gas flows in this space, so that the secondary flow of a gas can be restrained as in the foregoing embodiment.

Furthermore, the gas stopper projection does not need to contact at least a portion of the outer periphery of the gas channel-forming portion 14. It suffices that the gas stopper projection be disposed at such positions as to hinder the gas flow between the gas channel-forming portion 14 and the first linear projection 62 surrounding the gas channel-forming portion 14. An example of this construction is shown as a cell assembly 210 that includes a seal portion 216 provided with gas stopper projections 260 in FIG. 10B, in a plan view similar to that shown in FIG. 3. In FIG. 10B, the same portions as those in the foregoing embodiment are assigned with the same reference numerals, and the gas stopper projections 260 are shown by dot shading. In this case, too, the secondary flow of a gas can be restrained as in the foregoing embodiment.

Thus, even in the case where the gas stopper projection is formed in a shape different from the shape thereof in the foregoing embodiment, it suffices that the gas stopper projection be formed so as to have such a height to restrain the leakage of the gas in the inside-cell gas channel whereas the first and second linear projections 62, 64 need to be formed so as to have such a height as to restrain the leakage of the gases in the manifolds. Therefore, regardless of the shape of the gas stopper projection, it suffices that the gas stopper projection be formed to be lower than the first and second linear projections 62, 64. This restrains the decline in the surface pressure in the vicinity of the outer periphery of the gas channel-forming portion. In addition, in the case where only the first linear projection 62 surrounds the entire outer periphery of the gas channel-forming portion 14, the first linear projection 62 needs to have such a height as to restrain the gas leakage from the inside-cell gas channel, and satisfies this condition since the first linear projection 62 has such a height that the leakage of the gases in the manifolds can be restrained.

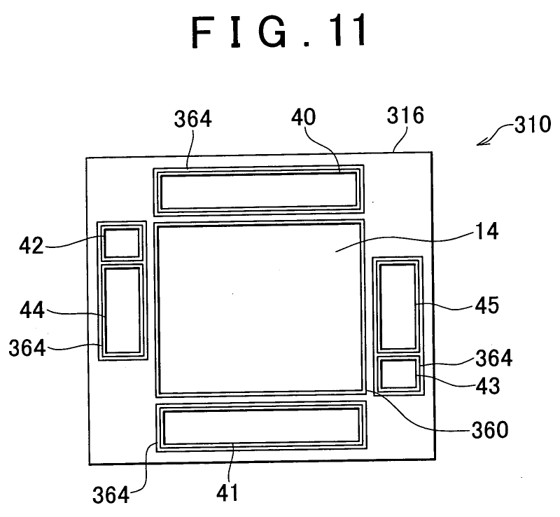

It is also permissible to form a gas stopper projection that surrounds the entire outer periphery of the gas channel-forming portion 14 in contact with the outer periphery thereof and also provide, apart from the gas stopper projection, linear projections that surround the entire outer periphery of each of the manifold hole portions. This construction is shown as a cell assembly 310 that includes a seal portion 316 provided with a gas stopper projection 360 in FIG. 11, in a plan similar to that shown in FIG. 3. In this case, it suffices that the linear projections 364 be formed so as to have such a height that gas seal property can be secured against the gas pressure in the manifolds. Besides, it suffices that the gas stopper projection 360 be formed so as to have such a height that gas seal property can be secured against the gas pressure in the inside-cell gas channel, and be formed so as to be lower than the linear projections. Therefore, by providing the gas stopper projection 360 in contact with the gas channel-forming portion 14 the secondary flow of the gas is restrained, and by forming the gas stopper projection 360 so as to be lower than the linear projections 364 the decline in the surface pressure acting in the vicinity of the outer periphery of the gas channel-forming portion 14 is restrained.

Although in the foregoing embodiment, the seal portion 16 has a flat surface on the side that contacts the anode-side plate 32, and is provided with the gas stopper projection 60 and the linear projections on the side that contacts the cathode-side plate 31, the seal portion 16 may have a different shape. For example, the surface provided with projections and the flat surface may be reversed in position to provide the gas stopper projection 60 and the linear projections on the side that contacts the anode-side plate 32.

In the case where the flat surface of the seal portion and the gas separator are to be adhered and closely attached to each other, it is possible to adopt various techniques besides the method in which a silane coupling agent is added to the molding material of the seal portion as in the embodiment. For example, it is possible to utilize a chemical bond, such as the intermolecular force, the covalent bond, the hydrogen bond, etc., or a physical bond, such as a mechanical bond or the like. Besides, an adhesive layer made of an adhesive may also be provided between the flat surface of the seal portion and the gas separator.

In the case where the surface of the seal portion 16 that contacts the anode-side plate 32 is formed as a flat surface and is adhered and closely attached to the gas separator, the seal property with regard to hydrogen, which is prone to leak, can be further enhanced. Besides, in the case where the surface of the seal portion 16 that contacts the cathode-side plate 31 is adhered and closely attached to the gas separator, seal property can be enhanced on the oxidizing gas side where the gas pressure is generally higher.

Furthermore, even in the case where the seal portion and the gas separator are formed as separate bodies and then stacked without performing a special process of adhering the flat surface of the seal portion and the gas separator, by forming the projections only on one side of the seal portion, the projections are stabilized. Thus, the effect of facilitating the securement of seal property can be attained. In the case where the seal portion and the gas separator are formed as separate bodies, the two gas channel-forming portions may be formed separately from the seal portion, and after that, may be fitted to the seal portion.

Furthermore, the seal portion may also be formed so as to have the gas stopper projections and the linear projections provided at mutually corresponding positions on both side surfaces, instead of having a flat surface on one side. This construction also achieves similar effects of restraining the secondary flow of the gas in the inside-cell gas channel and restraining the decline in the surface pressure acting in the vicinity of the outer periphery of the gas channel-forming portion.

Although in the foregoing embodiment, the fuel cell is a solid polymer fuel cell, the fuel cell may also be of a different kind. For example, the fuel cell may be a solid oxide electrolyte fuel cell. The invention is applicable to any fuel cell if the fuel cell has an operation temperature range that allows a component material of the seal portion to be appropriately selected from elastic materials such as rubber, thermoplastic elastomers, etc.

What is claimed is:

1. A fuel cell comprising:
a membrane-electrode assembly that includes an electrolyte membrane, and electrodes formed on two sides of the electrolyte membrane;
a seal portion that is made of an elastic body and that is formed integrally with the membrane-electrode assembly at an outer peripheral portion of the membrane-electrode assembly;
gas separators that are each disposed at a predetermined distance from the membrane-electrode assembly so as to sandwich the seal portion from two sides; and
gas channel-forming portions that are each made of a porous body and that are disposed between the membrane-electrode assembly and the gas separators,
wherein the seal portion includes, as projections that are provided on at least one of two sides of the seal portion and that contact an adjacent one of the gas separators, a first linear projection that surrounds the gas channel-forming portions, and a gas stopper projection which is provided at such a position between the first linear projection and an outer periphery of the gas channel-forming portions as to inhibit a gas flow that passes around the gas channel-forming portions, and which is lower in height than the first linear projection.

2. The fuel cell according to claim 1, wherein the gas stopper projection has such a height as to restrain leakage of the gas that flows in the gas channel-forming portion.

3. The fuel cell according to claim 1, wherein the gas stopper projection is in contact with the outer periphery of the gas channel-forming portions and surrounds the gas channel-forming portions.

4. The fuel cell according to claim 1, further comprising gas diffusion layers that sandwich the membrane-electrode assembly and are disposed on the electrodes, and that are each made of a porous body whose average pore diameter is smaller than the average pore diameter of the gas channel-forming portions, wherein:
the seal portion is formed integrally with the membrane-electrode assembly and with the gas diffusion layer; and
the gas channel-forming portions are disposed between the gas diffusion layer and the gas separators.

5. The fuel cell according to claim 1, wherein the seal portion is formed integrally with the membrane-electrode assembly and with the gas channel-forming portion.

6. The fuel cell according to claim 1, wherein each gas separator has:
a gas supply passage that is formed within the gas separator as a channel of a gas supplied to the gas channel-forming portion; and
an opening portion of the gas supply passage that is formed in a contact surface between the gas separator and the gas channel-forming portion.

7. The fuel cell according to claim 6, wherein:
the seal portion is formed integrally with the membrane-electrode assembly and with one of the gas separators adjacent to the membrane-electrode assembly;
a side of the seal portion that contacts the one of the adjacent gas separators is formed as a flat surface, and has a surface contact with the one of the adjacent gas separators; and
the seal portion has the first linear projection and the gas stopper projection on a side that contacts another one of the adjacent gas separators.

8. The fuel cell according to claim 6, wherein:
the seal portion is adhered or closely attached to one of gas separators that is adjacent to the seal portion; and
the seal portion has the first linear projection and the gas stopper projection on a side that contacts another one of the adjacent gas separators.

9. The fuel cell according to claim 1 that is formed by stacking a plurality of membrane-electrode assemblies with the gas separators disposed between the membrane-electrode assemblies, wherein:
the gas separators and the seal portion each have, at positions that correspond to each other, a hole portion that forms a gas manifold which penetrates through the fuel cell in a stacking direction and through which a gas to be supplied to each of the membrane-electrode assemblies flows;
the first linear projection surrounds the gas channel-forming portion, and is disposed along a portion of an outer periphery of the hole portion;
the seal portion further has, as a projection that is provided on at least one of two sides of the seal portion so as to contact an adjacent one of the gas separators, a second linear projection that is continuously provided with a height substantially the same as the height of the first linear projection, and that surrounds the hole portion together with the portion of the first linear projection; and
the first linear projection and the second linear projection have such a height as to restrain leakage of the gas that flows in the gas manifold.

10. A fuel cell comprising:
a membrane-electrode assembly that includes an electrolyte membrane, and electrodes formed on two sides of the electrolyte membrane;
a seal portion that is made of an elastic body and that is formed integrally with the membrane-electrode assembly at an outer peripheral portion of the membrane-electrode assembly so as to embrace the outer peripheral portion of the membrane-electrode assembly;
gas separators that are each disposed at a predetermined distance from the membrane-electrode assembly so as to sandwich the seal portion from two sides; and
gas channel-forming portions that are each made of a porous body and that are disposed between the membrane-electrode assembly and the gas separators,
wherein the fuel cell is formed by stacking a plurality of membrane-electrode assemblies with the gas separators disposed between the membrane-electrode assemblies, and
wherein the gas separators and the seal portion each have, at positions that correspond to each other, a hole portion that forms a gas manifold which penetrates through the fuel cell in a stacking direction and through which a gas to be supplied to each of the membrane-electrode assemblies flows, and
wherein the seal portion includes, as projections that are provided on at least one of two sides of the seal portion so as to contact an adjacent one of the gas separators, a gas stopper projection that is in contact with an outer periphery of the gas channel-forming portions and that surrounds the gas channel-forming portions, and a linear projection that surrounds an outer periphery of the hole portion and that is higher than the gas stopper projection.

11. The fuel cell according to claim 10, wherein:
the gas stopper projection has such a height as to restrain leakage of the gas that flows in the gas channel-forming portion; and
the linear projection has such a height as to restrain leakage of the gas that flows in the gas manifold.

12. A cell assembly for a fuel cell, comprising:
a membrane-electrode assembly that includes an electrolyte membrane, and electrodes formed on two sides of the electrolyte membrane; and
a seal portion that is made of an elastic body and that is formed integrally with the membrane-electrode assembly at an outer peripheral portion of the membrane-electrode assembly,
wherein the seal portion includes, as projections that are provided on at least one of two sides of the seal portion and that contacts adjacent gas separators that are each disposed at a predetermined distance from the membrane-electrode assembly so as to sandwich the seal portion from the two sides, a first linear projection that is made of a porous body and that is provided so as to surround gas channel-forming portions disposed between the membrane-electrode assembly and the gas separators, and a gas stopper projection which is provided at such a position between the first linear projection and an outer periphery of the gas channel-forming portions as to inhibit a gas flow that passes around the gas channel-forming portions, and which is lower in height than the first linear projection.

13. A fuel cell comprising:
a membrane-electrode assembly that includes an electrolyte membrane, and electrodes formed on two sides of the electrolyte membrane;
a seal portion that is made of an elastic body and that is formed integrally with the membrane-electrode assembly at an outer peripheral portion of the membrane-electrode assembly;
gas separators that are each disposed at a predetermined distance from the membrane-electrode assembly so as to sandwich the seal portion from two sides; and
gas channel-forming portions that are each made of a porous body and that are disposed between the membrane-electrode assembly and the gas separators,
wherein the seal portion includes, as projections that are provided on at least one of two sides of the seal portion and that contact an adjacent one of the gas separators, a first linear projection that surrounds the gas channel-forming portions, and a gas stopper projection which is provided at such a position between the first linear projection and an outer periphery of the gas channel-forming portions as to inhibit a gas flow that passes around the gas channel-forming portions, and which is lower in a pressing pressure on the gas separator after assembly of the fuel cell than the first linear projection.
